(19) United States
(12) Patent Application Publication
(10) Pub. No.: US 2006/0171028 A1
(43) Pub. Date: Aug. 3, 2006

(54) Device and method for display capable of stereoscopic vision

(75) Inventors: Michio Oikawa, Sagamihara (JP); Takafumi Koike, Sagamihara (JP); Kei Utsugi, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Displays, Ltd., Chiba (JP)

(21) Appl. No.: 11/321,401

(22) Filed: Dec. 28, 2005

(30) Foreign Application Priority Data
Jan. 28, 2005 (JP) 2005-020545

(51) Int. Cl. G02B 27/22

(52) U.S. Cl. 359/463

(57) ABSTRACT

Devices that provide stereoscopic vision by placing a lens array or a pinhole array on a display have a problem. The resolution of an object in the background present at a great distance is degraded. With respect to a three-dimensional object of interest, an intermediate stereoscopic image. This intermediate image is synthesized with a two-dimensionally projected background image separately prepared to obtain another image, and this image is displayed on a stereoscopic display.

### BACKGROUND

The present invention relates to a device that provides stereoscopic vision and in particular to an autostereoscopic vision device wherein stereoscopic vision can be implemented with the naked eye.

Recently, the resolutions of displays have been enhanced, and fabrication techniques for microlenses have been improved. In this context, there is a market trend toward displays with autostereoscopic vision utilizing integral photography (hereafter, referred to as “IP”) (M. G. Lippmann, “Epreuves reversibles donnant la sensation du relief,” J. de Phys., vol. 7, 4th, series, pp. 821-825, November 1908). The IP is a system based on the reproduction of three-dimensional light sources.

Also, there are multi-view stereoscopic display devices that create a stereoscopic effect only in the lateral direction using lenticular lenses or parallax barriers. As illustrated in FIG. 14, the method on which these devices are based is basically intended to present an image that gives a binocular parallax to the left and right eyes 20 and 21. It can be thought to be a special form of the IP.

In these stereoscopic display devices, the pixels of a display have a finite quantity and a finite size. Therefore, these display devices have a problem. When a far-off object in the background is depicted, the resolution is degraded.

To cope with this, a technique to dispose a variable-focal length lens in front of a microlens to widen the range in which depth is represented has been developed, as disclosed in Japanese Unexamined Patent Publication No. 2001-238229.

To provide a three-dimensional sense and further improve the amount of data and rendering speed with a conventional two-dimensional display unit, there is known the following method: a two-dimensionally projected image is used for the background, and a character of interest is realistically rendered using a three-dimensional model; and this character is synthesized into the two-dimensional background.

### SUMMARY

Description will be given to the IP with reference to FIG. 11 to FIG. 13. A lens array 2 in which convex lenses are arranged in an array is installed on the front face of a display device 1. FIG. 11 illustrates the stereoscopic positional relation, and FIGS. 12 and 13 show a section taken therefrom. In a case where the pixels of the display are very small relative to the lenses, the following takes place when only the pixel in the position indicated by an open circle in FIG. 11 is displayed in some color with some brightness on the display 1: light is focused on the position indicated by the open circle, marked with numeral 50, by the effect of the lens array 2, and it becomes rays of light that are widened therefrom.

When an observer 20 views it within the range of view angle, indicated by numeral 51, it is possible to make the observer perceive as if a point light source, that is, an object were present in the position marked with numeral 50. Pinholes may be used in place of these lenses.

FIG. 12 shows an ideal state in which the display device 1 comprises a large amount of very small pixels. In reality, the pixels of the display device 1 have a finite size and a finite quantity, as illustrated in FIG. 13. The following is apparent from this with respect to the three-dimensional position of a light source that can be represented as a region obtained by connecting the center of a lens and both the ends of a pixel of the display device 1: the representable resolution is poorer in region 36 farther from the lens array 2 than region 35.

That is, there is the following problem: the farther an object to be depicted is positioned from lenses, the more the resolution is degraded. It can be conversely thought that the resolution is highest on the plane of the lens array. As an example, it will be assumed that the image 54 of a wall as the projected background is present in the position of the plane of the lens array 2, as illustrated in FIG. 15. When this image is displayed as a stereoscopic image, the stereoscopic display can be accomplished with the highest resolution. When the display is made as mentioned above, however, a problem arises. Part of a three-dimensional object 8 present behind the background image, such as region 55 in FIG. 15, cannot be displayed.

With the technique disclosed in the above-mentioned patent document 1, the range of representation of depth can be widened to some extent by utilizing a lens aside from the lens array 2. However, the technique cannot solve the problem that, when infinity is represented, a blur occurs. When actually implementing the device is considered, another problem arises. The number of components is increased, and this makes the device expensive.

According to the present invention, stereoscopic vision can be provided with the enhanced apparent resolution of the background by the taking the following procedure: humans' illusion and the like are utilized, and an stereoscopic image is created by ray tracking or with multiple camera parameters and a two-dimensionally projected background image, separately created, are synthesized together.

### BRIEF DESCRIPTION OF THE DRAWINGS

FIG. 1 is a block diagram illustrating an example of an stereoscopic image generation and output device and an autostereoscopic display.

FIG. 2 is a drawing illustrating an example of the flow of processing carried out when stereoscopic image is displayed using the device illustrated in FIG. 1.

FIG. 3 is a sectional view explaining a technique to generate a stereoscopic image.

FIG. 4 is a conceptual rendering illustrating the way a background image is acquired.

FIG. 5 is a drawing illustrating an example of the flow of processing of Step S5 in FIG. 2 in detail.

FIG. 6 is an explanatory drawing illustrating an example in which the image of a three-dimensional object is picked up from multiple viewpoints by live action shot.

FIG. 7 is a block diagram illustrating an example in which a stereoscopic image generation device and a stereoscopic image output device exist separately from each other.

FIG. 8 is a sectional view illustrating a method of generating a stereoscopic-image by parallel projecting 3D data onto multiple planes of projection.

FIG. 9 is a sectional view illustrating a method of generating 3D data from an image perspectively projected from multiple viewpoints.

FIG. 10 is an explanatory drawing illustrating an example of a case where a 360° background image is generated.

FIG. 11 is a three-dimensional explanatory drawing illustrating the principle of the IP based autostereoscopic display.

FIG. 12 is a two-dimensional explanatory drawing illustrating a section taken from FIG. 11.

FIG. 13 is an explanatory drawing illustrating the resolution of a reproduced light source according to the distance from a display in the IP.

FIG. 14 is a conceptual rendering of the multi-view stereoscopic vision.

FIG. 15 is an explanatory drawing illustrating a problem that arises when the resolution is enhanced by displaying a background image plane of the lens array on the plane of the lens array.

### DESCRIPTION OF THE PREFERRED EMBODIMENTS

Description will be given to stereoscopic display obtained by displaying an image generated by a program that generates an intermediate image for stereoscopically displaying a three-dimensional object, a program that generates a background image, and a program that synthesizes an intermediate image and a background image.

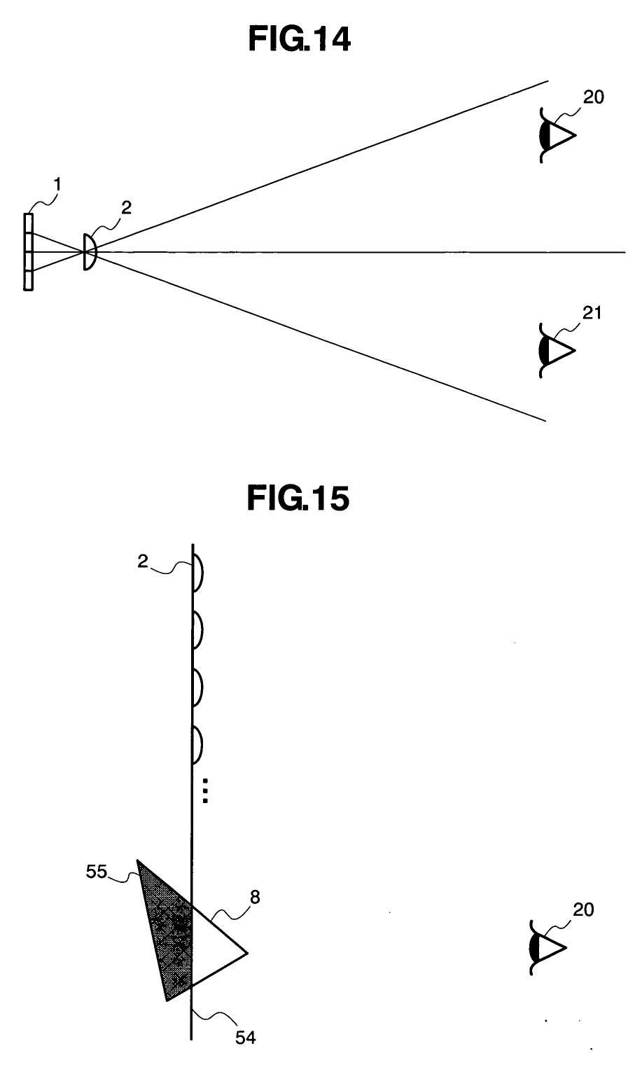

The present invention produces the effect of producing display in which the resolution of a three-dimensional image looks enhanced. This will be described with reference to, for example, FIG. 14. When multi-view stereoscopic vision is provided, image information having a parallax is displayed with respect to a pixel viewed from viewpoints 20 and 21, and the stereoscopic effect is thereby produced. Meanwhile, it will be assumed that a two-dimensionally projected background image is displayed on a display 1. In this case, the image that can be viewed at viewpoints 20 and 21 is not information having a parallax but information on the background in different positions. For this reason, it is expected that correspondence cannot be established between the left and right eyes, and the image is one difficult to recognize. In reality, however, the following takes place possibly because the pieces of the information are those on adjacent pixels and they have similar pixel values: the background image is perceived as if it were displayed on the display surface, and its resolution is sensed to be high.

When a wall formed by projecting a background image is positioned on the plane of the lens array as mentioned above, a three-dimensional object behind the wall cannot be displayed. According to the present invention, a three-dimensional object positioned behind can also be displayed. In this case, a problem arises under ordinary circumstances. The anteroposterior relation between a three-dimensional object positioned behind and a background image is inverted. However, this is negligible. Humans perceive an image looking like a background as a background, and thus the stereoscopic effect without problems can be produced as a whole.

### First Embodiment

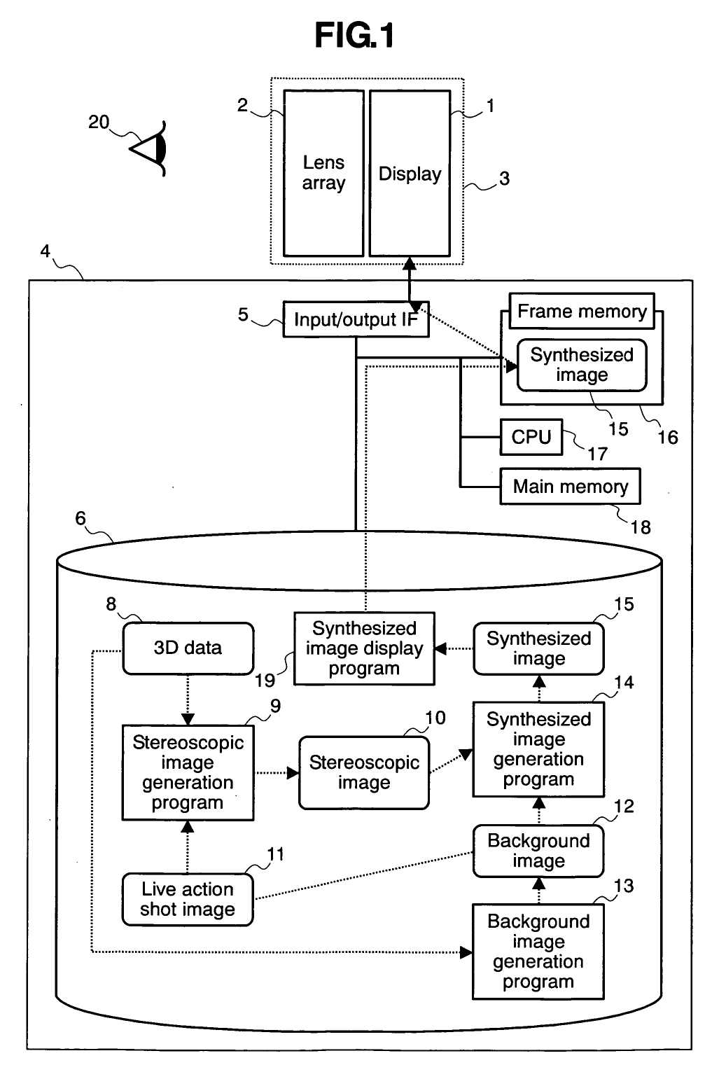

FIG. 1 is a block diagram illustrating a first embodiment, and arrows of dotted line in the figure show the conceptual flow of data. Description will be given to individual components and the relation between the components with reference to this figure.

A stereoscopic display 3 is a combination of a display 1 that displays an ordinary two-dimensional image and a convex lens array 2. An observer 20 observes the stereoscopic display 3 from the convex lens array 2 side.

For an image generation and output device 4 for stereoscopic vision, for example, a commonly used computer is used. A storage device 6 stores data and programs, which are loaded to a main memory 18 through OS (Operating System) as required. Computation is carried out at CPU 17.

The CPU 17 is a computing unit and may be constructed of multiple processors. Or, it may be DSP (Digital Signal Processor) or GPU (Graphics Processor Unit). In a case where the CPU 17 is GPU, the main memory 18 maybe a memory on a graphics board.

First, according to the specifications of the stereoscopic display 3, an stereoscopic image 10 is generated from 3D data defined at the storage device 6 by a stereoscopic image generation program 9. The generation method will be described later. The stereoscopic image 10 may be generated from live action shot images, picked up by cameras from multiple view points, by the stereoscopic image generation program 9.

Next, part of a live action shot image 11 is defined as a background image 12. The stereoscopic image 10 and the background image 12 are synthesized together to generate a synthesized image 15 by a synthesized image generation program 14. The synthesis method will be described later. The background image 12 may be generated by a background image generation program 13 utilizing the 3D data 8.

The synthesized image 15 is loaded to a frame memory 16 by a synthesized image display program 19 through the OS, and is outputted to the stereoscopic display 3 via an input/output IF 5.

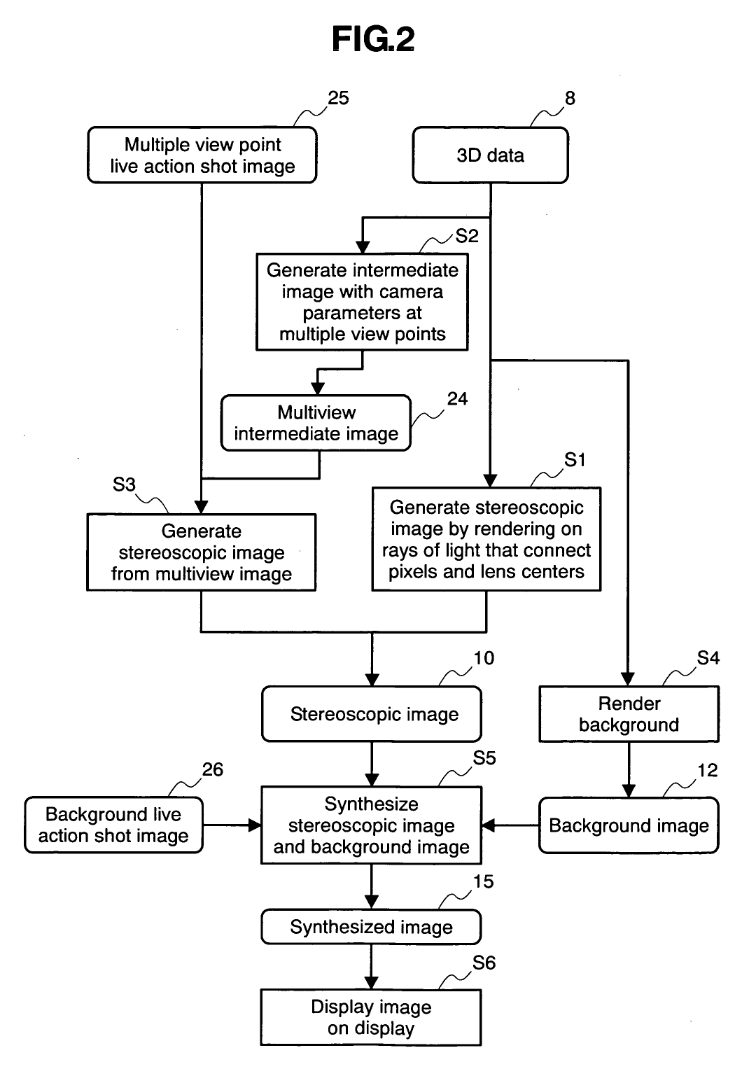

Description will be given to an embodiment that can be implemented with the construction illustrated in FIG. 1 with reference to the flowchart in FIG. 2 from the aspect of program.

There are three different methods for generating a stereoscopic image 10 in the case illustrated in FIG. 2. This embodiment uses the following method: utilizing the 3D data 8, rendering is carried out on rays of light that connect pixels and lens centers by the stereoscopic image generation program 9 in FIG. 1, and a stereoscopic image is thereby generated (Step S1). This method will be described with reference to FIG. 3.

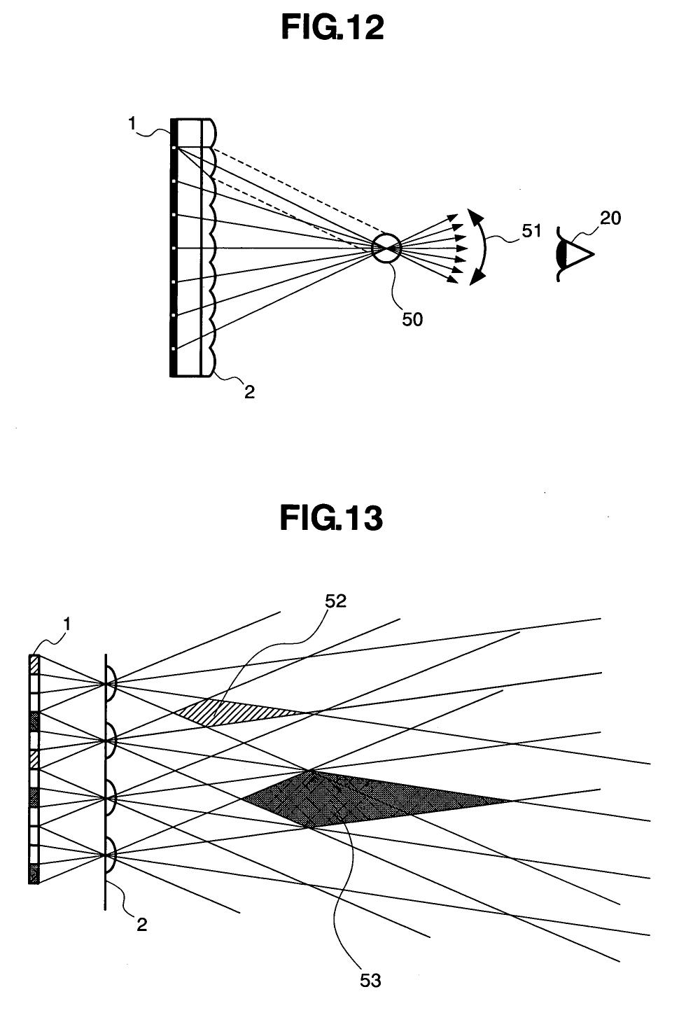

Like FIG. 12, FIG. 3 is a sectional view of the stereoscopic display 3. It will be assumed that at this time, there is the 3D data 8 represented by a circle and a triangle as illustrated in FIG. 3. A ray of light is drawn from the center of each pixel of the display 1 so that the ray of light passes through the center of the corresponding lens. The rays of light intersecting the 3D data 8 at this time are indicated by broken lines of the points of intersection of the rays of light and the surface of the three-dimensional object, points closest to the observer are indicated by filled circles 38. That is, in the generation method for stereoscopic image at Step S1 in FIG. 2, a stereoscopic image can be generated by determining the color and brightness of each of the filled circles 38 in FIG. 3.

Description will be given with reference to the flowchart in FIG. 2 again.

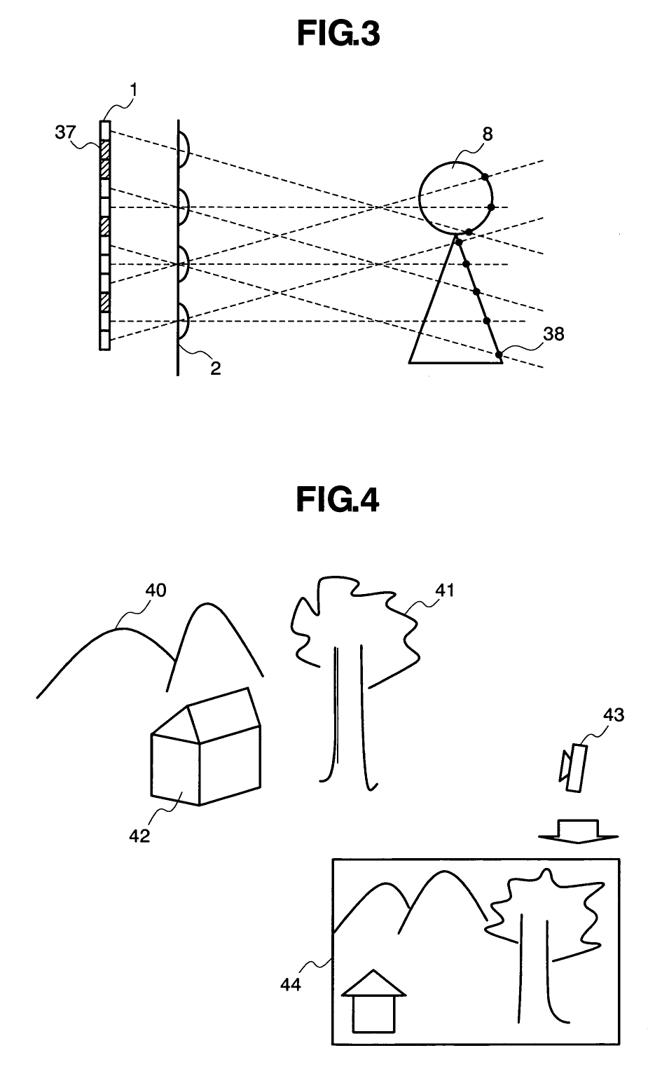

In this embodiment, a background live action shot image 26 is used as the background image. This is obtained by defining the live action shot image 11 in FIG. 1 as the background image 12. As illustrated in FIG. 4, for example, an image 44 obtained by shooting a landscape embracing a mountain 40, a tree 41, and a house 42 with a camera 43 is taken as the background live action shot image.

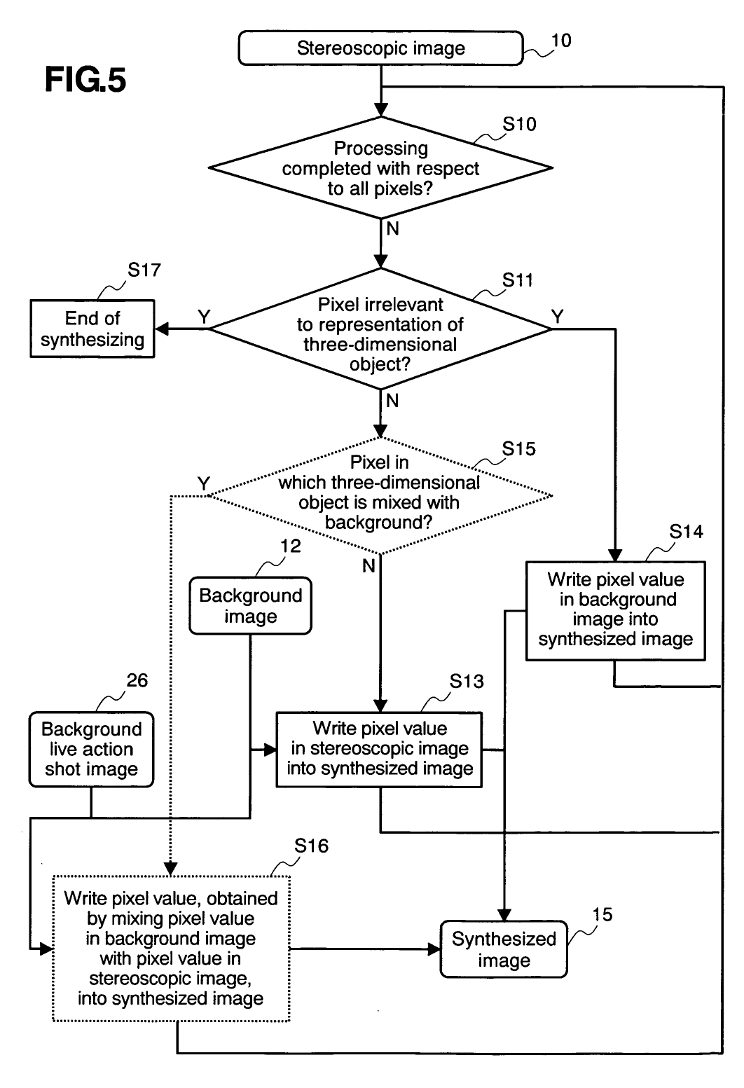

The stereoscopic image 10 and the background live action shot image 26 are synthesized together by the synthesized image generation program 14 in FIG. 1 (Step S5). Description will be given to this method for synthesis with reference to FIG. 3 and the flowchart in FIG. 5. FIG. 5 illustrates the details of Step S5 in FIG. 2.

When the stereoscopic image is generated through the processing of Step S1, of the pixels on the display 1, the pixels 37 indicated by hatching in FIG. 3 have no relation to the processing to represent the 3D data. Therefore, when the stereoscopic image 10 is generated at Step S1, the pixel values of the pixels 37 irrelevant to the representation of the 3D data are set to, for example, −1.

It is examined whether all the processing has been completed or not with respect to the stereoscopic image 10 (Step S10). If completed, the synthesizing process is ended (S17). If not, the pixel values of the pixels are examined one by one, and it is determined whether each pixel is irrelevant to the representation of the three-dimensional object (Step S11). (In this embodiment, an irrelevant pixel has a pixel value of −1.) When a pixel is irrelevant, the pixel value in the same pixel position in the background live action shot image 26 is written as a pixel value of the synthesized image 12 (Step S14). When a pixel is judged not to be irrelevant at Step S11, its pixel value in the stereoscopic image 10 can be written as a pixel value in the synthesized image 12 (Step S13).

The synthesized image 15 generated by the above-mentioned technique is displayed on the stereoscopic display by the synthesized image display program 19 in FIG. 1 (Step S6).

In the above-mentioned embodiment, stereoscopic 3D data can be displayed as stereoscopic vision over a live action shot background of high resolution. Thus, the apparent resolution can be enhanced to improve the quality of stereoscopic display.

### Second Embodiment

Description will be given to another embodiment in which an stereoscopic image 10 is generated, with reference to FIG. 2.

First, an intermediate image is generated from 3D data 8 with virtual camera parameters (position, number of pixels, angle of view, aspect ratio, etc.) at multiple viewpoints (Step S2). As illustrated in FIG. 8, for example, planes 61 to 63 of projection are prepared, and a multiview intermediate image 24 as a projection of the 3D data 8 is generated by parallel projection. The number of pixels on the display 1 assigned to one lens is basically taken as the number of planes of projection. However, it may be required to increase the number of planes of projection depending on the disposition of lenses.

As another method for generating a multiview intermediate image, the following procedure may be taken on the assumption of the principle of multi-view stereoscopic display: a multiview intermediate image 24 is generated as such an image as is obtained by observing the 3D data 8 from the positions of view points 65 to 67 by perspective projection, as illustrated in FIG. 9. The number of pixels on the display 1 assigned to one lens is basically taken as the number of viewpoints. However, it may be required to increase the number of viewpoints depending on the disposition of lenses.

With respect to each pixel on the multiview image 24 generated as mentioned above, a pixel value is assigned to the corresponding pixel on the display 1, and a stereoscopic image 10 is thereby generated (Step S3).

The subsequent steps are the same as in the first embodiment.

Use of this embodiment obviates necessity for preparing a rendering program dedicated to stereoscopic display. A stereoscopic image 10 can be generated by utilizing commercially available CG rendering software.

### Third Embodiment

Description will be given to another embodiment in which an stereoscopic image 10 is generated, with reference to FIG. 2.

As at Step S2 mentioned above, a multiple viewpoint live action shot image 25 is prepared on the assumption of the principle of multi-view stereoscopic display. (The live action shot image corresponds to part of the live action shot image 11 in FIG. 1.) The number of pixels on the display 1 assigned to one lens is basically taken as the number of these viewpoints. Instead, a method in which an image of intermediate viewpoint is estimated from an image of a smaller number of viewpoints may be used.

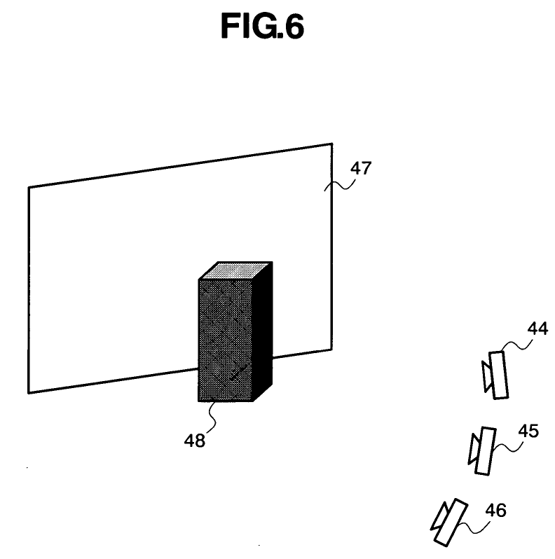

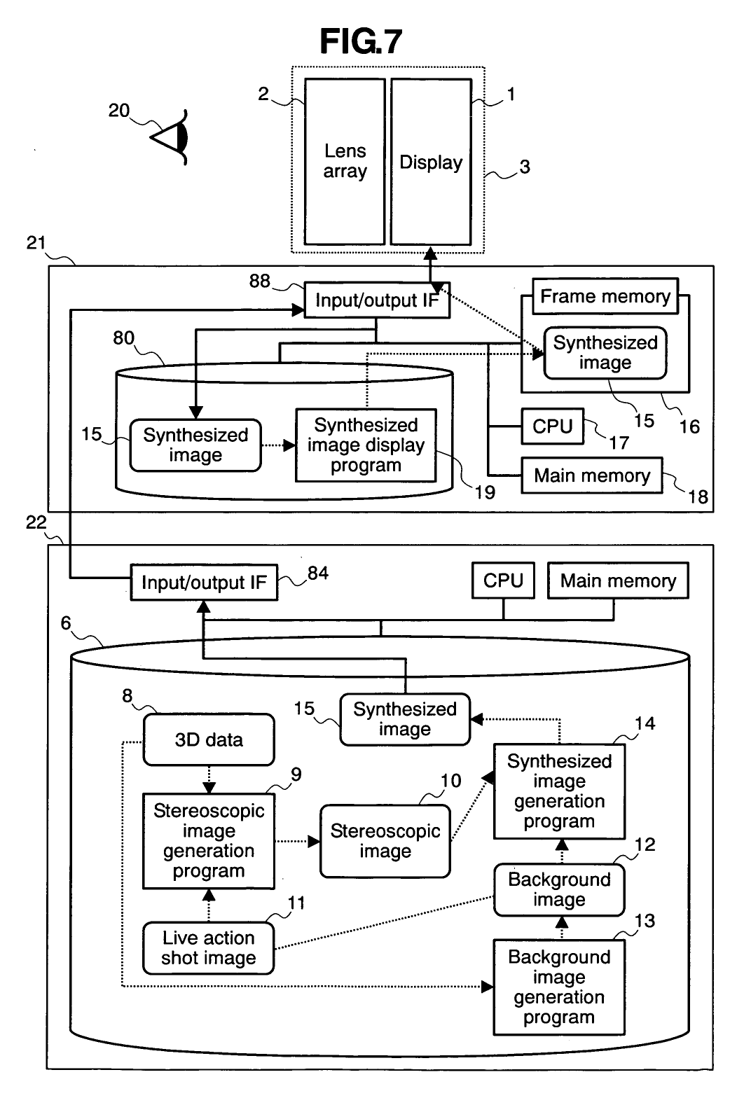

At this time, to divide a background and a three-dimensional object of interest from each other, a chroma key extraction technique for movies and television can be utilized. As illustrated in FIG. 6, a background 47 in one color, for example, green is placed behind a three-dimensional object 48, and the object is shot with cameras 44 to 46.

As in the second embodiment, pixels that correspond to pixels on the display 1 are picked up from the multiple viewpoint live action shot image 25, or the multiview image, prepared as mentioned above. Pixel values are assigned to these pixels, and a stereoscopic image 10 is thereby generated (Step S3).

The subsequent steps are the same as in the first embodiment. However, since there is a slight difference in the processing of Step S5, it will be described with reference to FIG. 5.

In the judgment at Step S11, whether a pixel is irrelevant to the representation of a three-dimensional object is determined by the color of the shot background. (In the example described in connection with FIG. 6, this color is green.)

In addition, the following procedure is taken in the third embodiment: when a live action shot picture is used, the boundary between a three-dimensional object and a background can be shot in one pixel. As a result, the outline of the three-dimensional object becomes obscure. To cope with this, the following processing can be performed: with respect to a pixel judged to be relevant at Step S11, it is further examined whether the three-dimensional object is blended with the background in the pixel (Step S15). With respect to a pixel in which the three-dimensional object is blended with the background, such processing as in conventional chroma key synthesis techniques is performed. That is, the blend ratio is estimated, and a synthesized image 15 is generated using a pixel value obtained by mixture with the pixel value of the corresponding pixel in the background live action shot image 26 (Step S16).

According to this embodiment, as mentioned above, the following can be implemented by using only a live action shot image: the unnaturalness of a three-dimensional object at the boundary is eliminated, and further stereoscopic vision is displayed with the resolution of an image as the background being high.

### Fourth Embodiment

Description will be given to another embodiment relating to background image with reference to FIG. 2.

In the above-mentioned embodiments, a live action shot image is used as the background image. The recent advancement of rendering techniques has made high-resolution and realistic rendering possible. In this embodiment, consequently, a background image is generated from 3D data by the background image generation program 13 in FIG. 1. Like the background shot in live action described with reference to FIG. 4, for example, the pieces of 3D data for a mountain and a house are disposed in a three-dimensional space in a computer. Then, a background image 12 with high resolution is generated by a rendering technique that obtains high image quality (Step S4).

The same processing as in the first to third embodiments mentioned above can be performed except that the background image 12 is used as the background image, in place of the background live action shot image 26. That is, the processing of Step S15 and Step S16 maybe performed or may not be performed. For example, in a case where antialiasing has been enabled when an stereoscopic image 10 is generated, a blue wall or the like is defined as 3D data and the stereoscopic image 10 is generated as in the case of live action shot. Thus, the outline of the three-dimensional object is blended with blue in the background. In this case, the processing of Step S15 and Step S16 can be performed as in the third embodiment.

According to this embodiment, a world that is impossible in live action shot can be utilized as the background. In a case where a stereoscopic image is generated from 3D data, contents without the sense of unnaturalness can be created. In a case where a stereoscopic image is generated from a live action shot image, contents that look as if a three-dimensional object shot in live action enters a CG world can be created.

### Fifth Embodiment

Further, description will be given to another embodiment relating to background image.

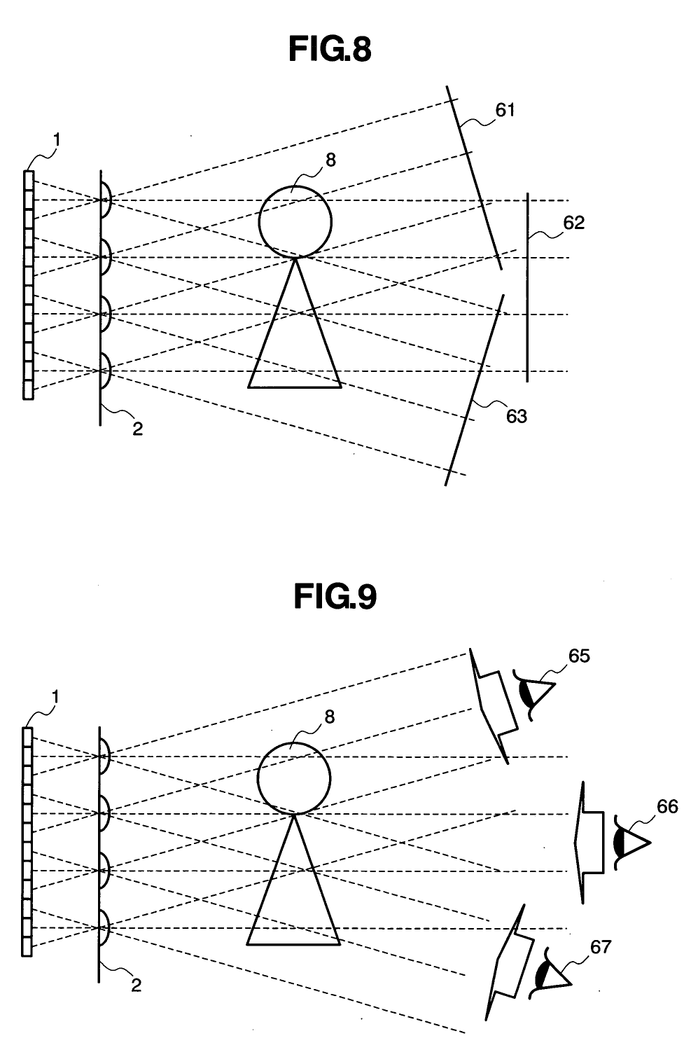

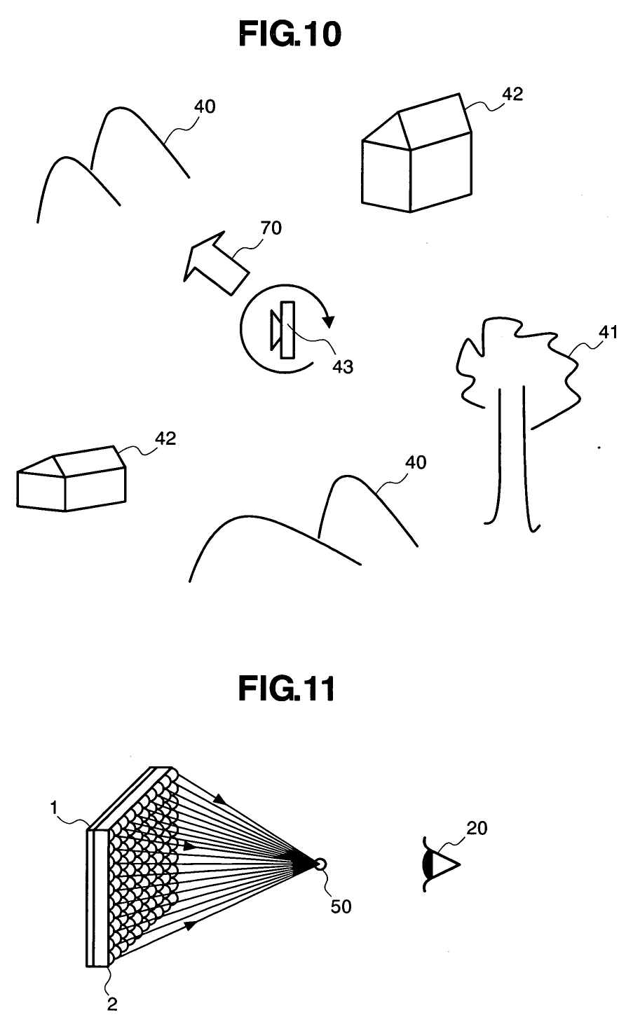

In a case where a background image 12 is generated from 3D data 8 as in the fourth embodiment, a 360° background image can be generated by placing pieces of 3D data around a virtual camera 43 for background rendering, as illustrated in FIG. 10.

Also, in live action shot, a 360° background live action shot image can be generated by panning the camera 360° to pick up the image or picking up the image with multiple cameras set with one point at the center.

Such a 360° background image or a background live action shot image is prepared, and at Step S5, it is synthesized with an stereoscopic image 10 generated with respect to a three-dimensional object in motion.

In a case where a three-dimensional object is present in the direction of arrow 70 in FIG. 10, for example, the following procedure can be taken: the background image in the direction of arrow 70 is cut out of the 360° background image in accordance with a predetermined angle of view for background image. Then, the three-dimensional object and the background image are synthesized together.

In this embodiment, the background behind a moving three-dimensional object changes according to the position of the three-dimensional object, and thus stereoscopic vision can be displayed over a wide range.

### Sixth Embodiment

Description will be given another embodiment relating to configuration with reference to FIG. 5.

In this embodiment, the stereoscopic image generation and output device 4 is divided into a stereoscopic image output device 21 and a stereoscopic image generation device 22. In this embodiment, the steps up to the generation of a synthesized image 15 can be carried out by the stereoscopic image generation device 22 similarly with those in the above-mentioned embodiments.

The generated synthesized image 15 is transmitted through the input/output IF 88 of the stereoscopic image generation device 22 and the input/output IF 84 of the stereoscopic image output device 21, and is stored in the storage device 80. This storage device 80 may be ROM in which information can be written only once or a hard disk or the like on which it can be rewritten any number of times.

In the stereoscopic image output device 21, the synthesized image 15 stored in the storage device 80 is loaded to the frame memory 81 by the synthesized image display program 19. It is transmitted through the input/output IF 84, and is displayed on the stereoscopic display 3. This display program 19 may change synthesized images 15 with predetermined timing in predetermined order and cause them to be displayed. Or, it may change synthesized images 15 according to interaction with a user, inputted through the input/output IF 84.

According to this embodiment, the stereoscopic image output device 21 can be reduced in size, and its application to a game machine or the like is facilitated.

With a stereoscopic display device according to the present invention, the following advantages are brought: the apparent resolution of a background can be enhanced without adding any hardware, and the effect of displaying a three-dimensional image so that its resolution looks improved is obtained.

What is claimed:

1. A display device having a display that displays an image and a lens array provided with a plurality of lenses corresponding to a plurality of the pixels of the display, comprising;
storing means that stores information: and
computing means that performs computation using the information, wherein
the computing means utilizes the three-dimensional information of a three-dimensional object stored in the storing means,
the computing means assigns the color and brightness representative of the three-dimensional object present in a region in which the rays of light outputted from the individual pixels of the display to a region within the range of display required to depict the three-dimensional object on the display device through the corresponding lenses are outputted, to the individual pixels, and thereby generates an intermediate image obtained by converting the two-dimensional image data into three-dimensional image,
with respect to an other two-dimensional image stored in the storing means, the computing means synthesizes the data of the other two-dimensional image in a region out of the range of display required to depict the three-dimensional object over the other two-dimensional image on the display device with the intermediate image to generate a synthesized image, and causes the synthesized image to be displayed on the display.

2. The display device according to claim 1, wherein
the intermediate image is generated by projecting color information that is positioned on the view point side and in the position farthest from the display, on a three-dimensional object present on the rays of light connecting the pixels on the display and the centers of the,corresponding lenses onto an intermediate image with respect to all the pixels.

3. The display device according to claim 1, wherein
the intermediate image is generated from a plurality of projected images projected onto the planes of projection of cameras at a plurality of view points.

4. The display device according to claim 1, wherein
the other two-dimensional image is a background image, and the background image is an image projected onto the plane of projection of a camera at one view point.

5. The display device according to claim 1, wherein
the other two-dimensional image is a background image, and the background image is a live action shot image obtained by shooting a real space.

6. The display device according to claim 1, wherein
the other two-dimensional image is a background image, and the background image is an image obtained by cutting the background region in the direction in which the three-dimensional object is to be displayed out of an image picked up in 360 degrees with some view point at the center.

7. A display device having a display that displays an image and a lens array provided with a plurality of lenses corresponding to a plurality of the pixels of the display, comprising;
storing means that stores information: and
computing means that performs computation using the information; wherein
the storing means stores two-dimensional image data obtained by shooting an object to be stereoscopically displayed, placed in front of a background in one color, with cameras set in a plurality of positions,
the computing means extracts the two-dimensional image data of a three-dimensional object stored in the storing means,
the computing means assigns the color and brightness representative of the three-dimensional object present in a region in which the rays of light outputted from the individual pixels of the display to a region in the range of projection established when the three-dimensional object is projected from a plurality of view points through the corresponding lenses are outputted, to the individual pixels, and thereby generates an intermediate image,
with respect to a two-dimensional background image stored in the storing means, the computing means synthesizes the pixels of the intermediate image that contain the background in one color as was when the background was shot with the pixels of the background image to generate a synthesized image, and causes the synthesized image to be displayed on the display.

8. The display device according to claim 1, wherein
A pinhole array is used in place of the lens array.

9. The display device according to claim 1, wherein
a lenticular lens is used in place of the lens array.

10. A display method by using a display device having a display that displays an image and a lens array provided with a plurality of lenses corresponding to a plurality of the pixels of the display, comprising the steps of;
using a computing means that performs computation, and utilizing the three-dimensional information of a three-dimensional object stored in a storing means that stores information:
assigning the color and brightness representative of the three-dimensional object present in a region in which the rays of light outputted from the individual pixels of the display to a region within the range of display required to depict the three-dimensional object on the display device through the corresponding lenses are outputted, to the individual pixels, and thereby generating an intermediate image: and
with respect to an other two-dimensional image stored in the storing means, synthesizing the data of the other two-dimensional image in a region out of the range of display required to depict the three-dimensional object over the other two-dimensional image on the display device with the intermediate image to generate a synthesized image, and causing the synthesized image to be displayed on the display.

11. A display method by using a display device having a display that displays an image and a lens array provided with a plurality of lenses corresponding to a plurality of the pixels of the display, comprising the steps of;
storing two-dimensional image data, obtained by placing an object to be stereoscopically displayed in front of a background in one color and shooting the object with cameras set in a plurality of positions, in a storing means that stores information:
extracting the two-dimensional image data of a three-dimensional object stored in the storing means by a computing means that performs computation:
assigning the color and brightness representative of the three-dimensional object present in a region in which the rays of light outputted from the individual pixels of the display to a region within the range of projection established when the three-dimensional object is projected from a plurality of view points through the corresponding lenses are outputted, to the individual pixels, and thereby generating an intermediate image: and
with respect to a two-dimensional background image stored in the storing means, synthesizing the pixels of the intermediate image that contain the background in one color as was when the background was shot with the pixels of the background image, and thereby generating a synthesized image: and
causing the synthesized image to be displayed on the display.
